(19) United States
(12) Patent Application Publication
(10) Pub. No.: US 2015/0055697 A1
(43) Pub. Date: Feb. 26, 2015

(54) Method and Apparatus of Transform Process for Video Coding

(71) Applicant: MEDIA TEK INC., Hsin-Chu (TW)

(72) Inventors: Tung-Hsing Wu, Chiayi (TW); Kun-Bin Lee, Taipei (TW); Yi-Hsin Huang, Taoyuan (TW)

(73) Assignee: MEDIA TEK INC., Hsin-Chu (TW)

(21) Appl. No.: 13/970,896

(22) Filed: Aug. 20, 2013

(51) Int. Cl. H04N 19/122; H04N 19/176; H04N 19/105; H04N 19/147

(52) U.S. Cl. CPC H04N 19/00084; H04N 19/00175; H04N 19/00278; H04N 19/00024
USPC 375/240.02

(57) ABSTRACT

A method for transform processing in video coding is disclosed. Embodiments according to the present invention reduce the computational complexity of determining transform size for a processing block corresponding to a prediction block or a coding block. The transform size determination is based on encoder information or external information without comparing costs associated with different transform sizes. The encoder information can be the size of the processing block or the prediction information. The external information may correspond to the system bandwidth, the network bandwidth, the system power, the remaining energy of the battery in a mobile device, the timing budget related to performing transform for a given transform size. In another embodiment, the transform for each prediction block is performed only during cost evaluation or only during video data reconstruction.

### FIELD OF THE INVENTION

The present invention relates to video coding. In particular, the present invention relates to method and apparatus of transform process in a video coding system.

### BACKGROUND

With the advancement of video coding technology, the video coding algorithms have become increasingly complex. For example, a typical video coding system may involve Intra and Inter prediction, transform, quantization, inverse quantization and inverse transform. In order to select best system parameters, the costs and performances are evaluated for all possible system parameters. This selection process further increases system complexity. The complicated algorithms impose high requirement on hardware capability in terms of processing speed and power consumption. This is particularly true with the ever increasing demand of higher definition video.

In the High Efficiency Video Coding (HEVC) standard, three block concepts are introduced, i.e., coding unit (CU), prediction unit (PU), and transform unit (TU). The overall coding structure is characterized by the various sizes of CU, PU and TU. The CU, PU and TU may also called the coding block, prediction block and transform block respectively in this disclosure. Each picture is divided into largest CUs (LCUs) or Coding Tree Blocks (CTBs). Each LCU is then recursively divided into smaller CUs until leaf CUs or smallest CUs are reached. After the CU hierarchical tree is done, Inter or Intra prediction is applied to prediction units (PUs) according to partition type. Each PU may be partitioned into one or more smaller blocks (i.e., PUs. Residues are formed for each PU after applying Inter or Intra prediction. Furthermore, residues are partitioned into transform units (TUs) and two-dimensional transform is applied to the residue data to convert the spatial data into transform coefficients for compact data representation.

During video coding, source pixels of an image are processed by Inter or Intra prediction. By subtracting the predicted pixels from the original source pixels, the residue pixels (i.e., the residues) are generated as shown in FIG. 1A. Then residue pixels are processed by transform (T), quantization (Q), inverse quantization (IQ), inverse transform (IT) and other processing. TU size can be 16×16, 8×8 or 4×4 which are illustrated in FIG. 1B. FIG. 2 illustrates a flow chart for determining the transform size for a prediction block coded by Intra prediction. To determine the transform size for each prediction block, a block of source pixels corresponding to a prediction block is received as shown in step 210. An Intra prediction method is determined and Intra prediction is applied to the prediction block using the Intra prediction method determined to form prediction residues in step 220. The Intra prediction for the prediction block is based on the transform type determined in step 230, where the transform type corresponds to discrete cosine transform (DCT) or discrete sine transform (DST). When Intra prediction is selected for a block, the prediction data is formed based on spatial neighboring data that has been coded. In HEVC, directional Intra prediction has been introduced that includes horizontal, vertical and other angular directions. The cost (e.g., bit rate) and performance (e.g. distortion) associated with all possible transform sizes for the prediction block are evaluated in step 240. According to the rates and distortions computed for various transform sizes, a desired transform size is determined in step 250.

The coding process involves transform and quantization. In order to accurately evaluate the rate-distortion relationship, transform/quantization and inverse transform/quantization for a given transform size are performed on the residues in steps 241 and 242. The bit rate can be computed based on the quantized results from step 241. In FIG. 2, bit rate is performed as part of the function in step 244. After transform/quantization and inverse transform/quantization are performed on the residues, the processed residues can be added back to the Intra prediction data to form reconstructed prediction block as shown in step 243. After reconstructed prediction block is formed in step 243, the distortion between the original prediction block and the reconstructed prediction block can be evaluated in step 244. After the rate and distortion are computed for all possible transform sizes, the results are compared to select a desired transform size in step 250. The decision process is often referred to as rate-distortion optimization. In HEVC, a PU can be partitioned into one or more TUs. Therefore, the process in step 250 selects a best transform size according to rate-distortion optimization. However, an encoding system may use other cost-performance criterion to determine a desired transform size. The determination of the transform size may result in high computation complexity/power consumption, longer computation time, or high area cost for hardware implementation. Therefore, it is desirable to develop a method to simplify the process for transform size selection.

FIG. 3 illustrates one exemplary flow chart for an HEVC-based encoding system, where rate-distortion optimization is uses to determine TU size, PU size and CU size for a CU. As mentioned before, in HEVC, a CU may be partitioned into one or more CUs. After CU partition, a set of CUs is formed. Each CU in the CU set is used as a PU and the PU is partitioned into one or more PUs. After PU partition, a set of PUs is forms and the residues for each PU in the set of PUs are formed. The residues associated with each PU in the set of PUs are partitioned into one or more TUs. The rate-distortion optimization process has to compute the rate and distortion for all possible transform sizes associated with each PU. In FIG. 3, the residues associated each PU are received in step 310. The rates and distortions associated with all possible TU sizes for each PU are performed in block 240. According to the rates and distortions computed for all transform sizes, a transform size is selected for the PU in step 250. The cost of each PU with the determined transform size is determined in step 340. The costs of all different PU sizes for a PU of one CU are compared to determine the PU size for one CU size in step 350. The cost for a CU is computed based on the costs of all PUs in the CU as shown in step 360. The costs of different CU sizes are compared to determine the CU size as shown in step 370. Based on the selected CU size and PU size, the CU is reconstructed in step 380.

In a conventional encoding system, transform and inverse transform are perform for each PU in order to compute or estimate the bit rate and distortion associated with a selected transform size during the cost evaluation stage. FIG. 4 illustrates an exemplary flow chart of the cost computation on each PU in HEVC. The residues of one PU are received in step 410. Then transform and quantization associated with a transform size are performed on the residues in step 420 and inverse quantization and inverse transform are performed in step 430. The prediction is added to the processed residues in step 440 in order to reconstruct the PU for the purpose of determining distortion between the original PU and reconstructed PU. The cost (e.g. bit rate) and performance (e.g., distortion) of the PU is computed or estimated in step 450. FIG. 5 illustrates an exemplary flow chart of data reconstruction for each PU in HEVC. For a given transform size, the reconstruction process is similar to the cost evaluation process in FIG. 4, except that there is no need to compute the cost/performance.

As shown in FIG. 2 and FIG. 3, transform and inverse transform are performed for all possible transform sizes for each PU in a convention encoding system. In HEVC, each CU may be partitioned into one or more CUs and each PU may be partitioned into one or more PUs. The process to select a best transform size by performing transform/inverse transform for all possible transform sizes substantially increases the system complexity, power consumption or processing time in an HEVC-based encoding system. Furthermore, the transform/inverse transform has to be performed during cost evaluation and video data reconstruction, which further increases system complexity. Therefore it is desirable to simplify the process of determining the transform size and to eliminate the repeated transform/inverse transform process.

### BRIEF SUMMARY OF THE INVENTION

A method of applying transform processing to video data in a video coding system is disclosed. The video data is divided into a plurality of coding blocks. According to one embodiment of the present invention, the method comprises selecting a processing block, determining a transform size for the processing block and performing transform on the processing block with the transform size. The processing block corresponds to a prediction block from one coding block or the processing block corresponds to one coding block. The processing block may consist of a plurality of pixels processed by Intra prediction. The coding block may correspond to one Intra prediction coding block. The transform size is selected from a first group of supported transform sizes based on encoder information, external information or both. The transform size is selected without performing cost comparison among the first group of supported transform sizes. The encoder information may be selected from a second group consisting of size information of the processing block and prediction information of the processing block. The prediction information may comprise at least one of prediction direction and an analysis result of residues generated by a prediction process. The external information may be selected from a third group consisting of: a first amount of system bandwidth, a second amount of network bandwidth, a third amount of system power, a fourth amount of remaining energy of a battery in a mobile device; a fifth amount of timing budget for coding a plurality of pixels and computation capability of a system. The method may further comprise sharing Intra prediction information for transform blocks inside the processing block when the processing block consists of a plurality of transform blocks.

According to another embodiment of the present invention, the method of applying transform processing to video data in a video coding comprises: receiving one processing block of the video data, wherein the processing block comprises at least one prediction block; determining a transform size for said at least one prediction block, wherein the transform size is selected from a first group consisting of supported transform sizes; evaluating a PU cost for each prediction block; and reconstructing a reconstructed prediction block for each prediction block. In this method, transform with the transform size determined is applied to each prediction block only in said evaluating the PU cost for each prediction block or only in said reconstructing the reconstructed prediction block for each prediction block. The processing block may correspond to one prediction block. The processing block may correspond to one coding block and the coding block is divided into one or more prediction blocks according a CU partition selected from a partition set. When the processing block corresponds to one coding block, the method may further comprise selecting a desired CU partition according to CU costs associated with the CU partitions of the partition set and reconstructing the coding block based on the reconstructed prediction blocks generated from the coding block according to the desired CU partition. In selecting the desired CU partition, the CU cost associated with one CU partition is determined based on the PU costs of said one or more prediction blocks generated from the coding block according to said one CU partition. The coding block may correspond to an Intra-prediction coding block. In this method, each prediction block may consist of a plurality of pixels generated using Intra prediction. The transform size may be selected from a second group consisting of encoder information and external information. The encoder information may be selected from a third group consisting of size information of the coding block and prediction information of the processing block. The prediction information may comprise at least one of prediction direction and an analysis result of residues generated by a prediction process. The external information may be selected from a fourth group consisting of: a first amount of system bandwidth, a second amount of network bandwidth, a third amount of system power, a fourth amount of remaining energy of a battery in a mobile device, a fifth amount of timing budget for coding a plurality of pixels and computation capability of the video coding system. The method may further comprise sharing Intra prediction information for transform blocks inside each prediction block.

### BRIEF DESCRIPTION OF THE DRAWINGS

FIG. 1A illustrates an example of residues generation in video coding.

FIG. 1B illustrates an example of TU partition of residues into different TU sizes.

FIG. 2 illustrates an exemplary flow chart of traditional process for transform size determination.

FIG. 3 illustrates an exemplary flow chart of video encoding in HEVC.

FIG. 4 illustrates an exemplary flow chart of cost computation of a PU.

FIG. 5 illustrates an exemplary flow chart of video data reconstruction of a PU.

FIG. 6 illustrates an exemplary flow chart of determining transform size according to one embodiment of the present invention.

FIG. 7 illustrates an exemplary flow chart of determining transform size according to another embodiment of the present invention.

FIG. 8 illustrates an exemplary flow chart of determining transform size according to another embodiment of the present invention.

FIG. 9 illustrates an exemplary flow chart of determining transform size according to another embodiment of the present invention.

FIG. 10A illustrates an exemplary flow chart of video coding performing transform to a coding unit according to one embodiment of the present invention, where the system incorporates rate-distortion optimization to determine CU size and PU size.

FIG. 10B illustrates an exemplary flow chart of video coding incorporating a selected transform size among a group of supported transform sizes and performing one-time transform to a coding unit according to one embodiment of the present invention, where the system incorporates rate-distortion optimization to determine CU size and PU size.

FIG. 11A illustrates an exemplary flow chart of video coding performing one-time transform to a prediction unit according to one embodiment of the present invention.

FIG. 11B illustrates an exemplary flow chart of video coding performing one-time transform to a prediction unit according to another embodiment of the present invention.

FIG. 12 illustrates an exemplary flow chart of performing transform according to one embodiment of the present invention.

FIG. 13 illustrates an exemplary flow chart of performing transform to each prediction block according to one embodiment of the present invention.

FIG. 14 illustrates an exemplary flow chart of performing transform to each prediction block according to one embodiment of the present invention.

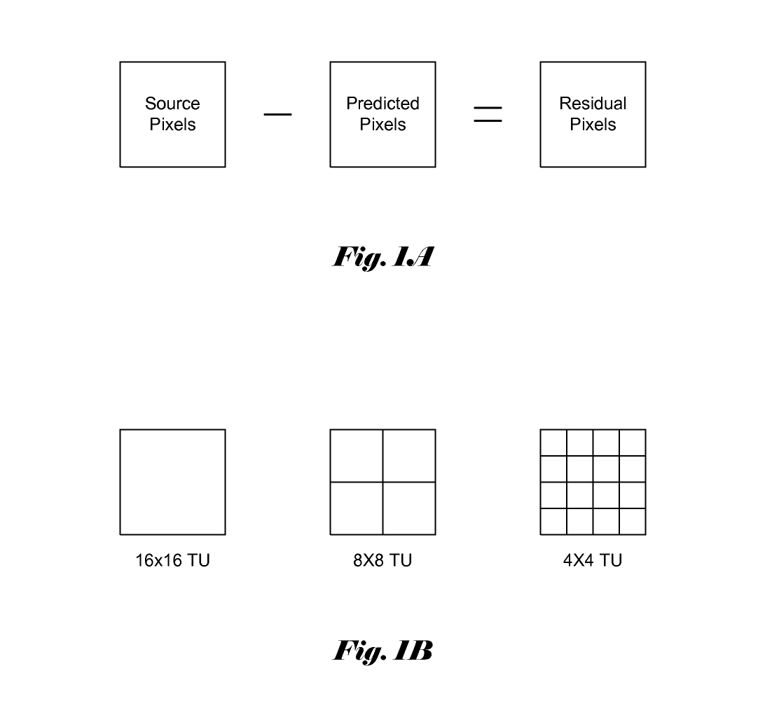

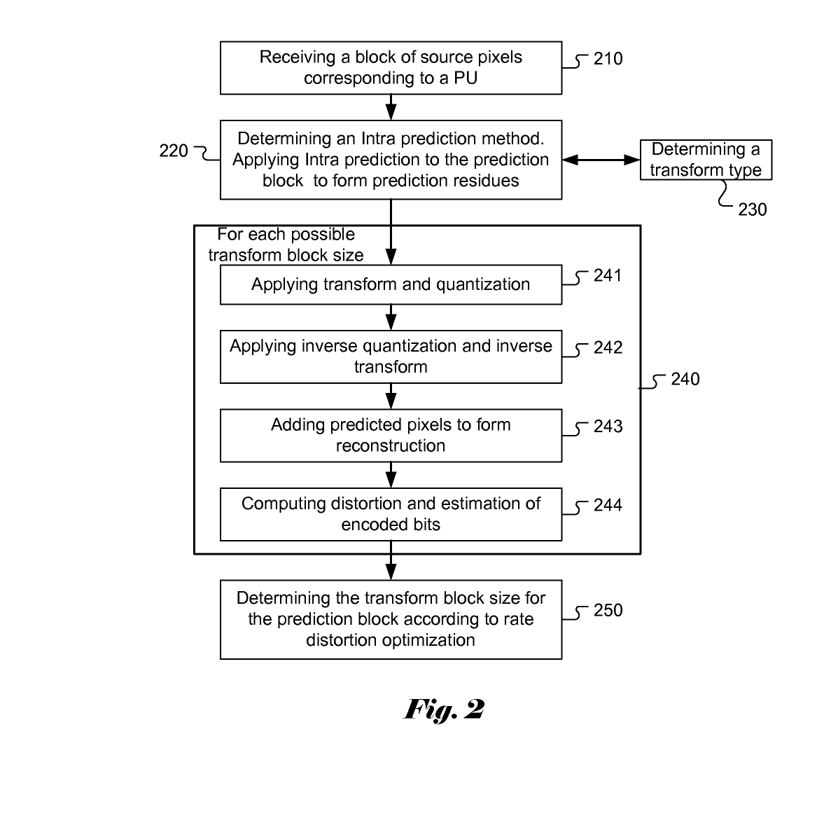

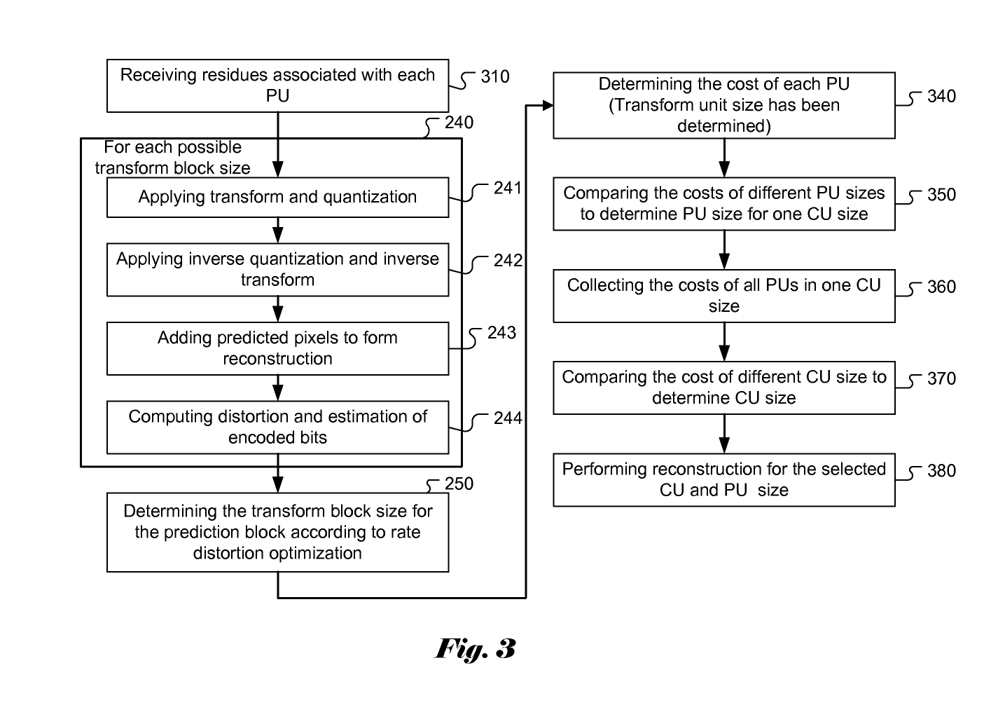

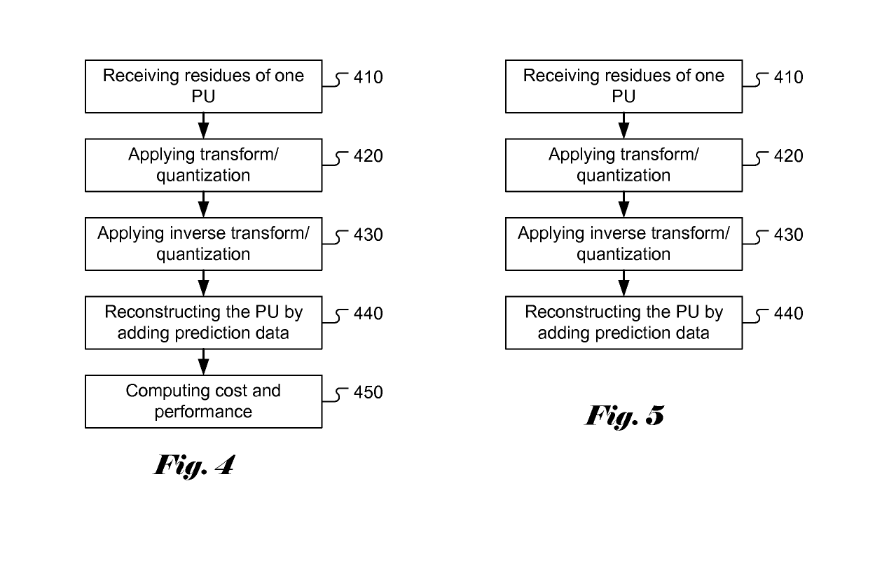

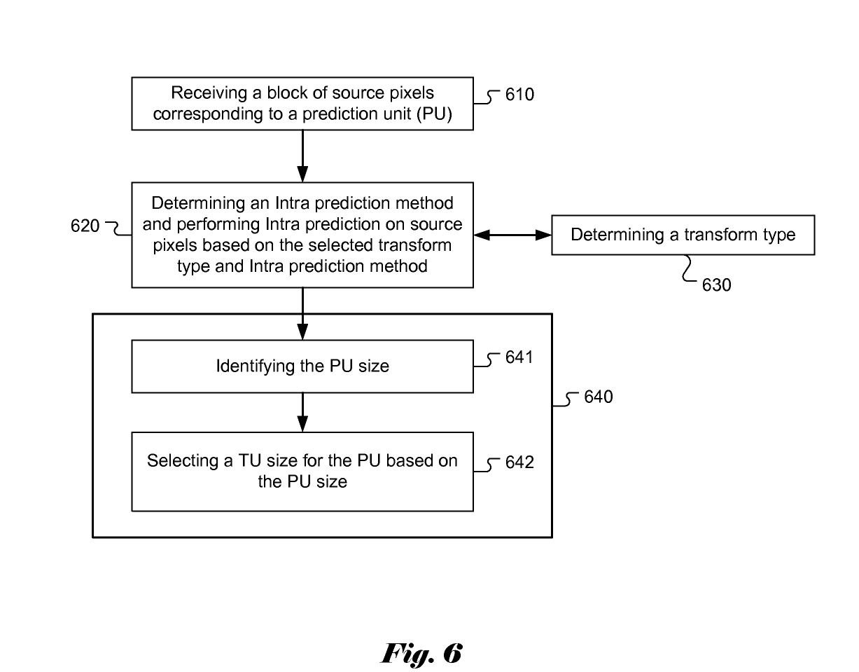

### DETAILED DESCRIPTION OF THE INVENTION

To reduce computational complexity associated with the transform size selection process involved in a conventional video coding system, a method of video coding using a selected transform size without comparing the costs associated with different transform size is disclosed in the present invention. One benefit of the simplified determination of the transform size is that the computational complexity is reduced since the transform size is determined before encoding the predicted block. Another embodiment of the present invention eliminates the repeated transform process in the evaluation stage and the reconstruction stage. Accordingly, the transform is performed only once to each prediction block in video coding process. The transform can be performed either during evaluating the cost of each prediction block or during reconstructing each prediction block. In addition, the computation time for software implementation or cost for hardware implementation may also be reduced by the simplified determination method of the transform size. The method according to the present invention may also result in less power consumption.

In the present invention, the transform size is determined directly without performing cost comparison among a group of supported transform sizes. A transform size is selected from a group of supported transform for a selected prediction block or a selected coding block. The supported transform sizes for a prediction block are not larger than the size of the selected prediction block or the selected coding block. The determination of the transform size is based on encoder information, external information or both. This is different from the conventional video coding system in which the transform size is determined based on the costs of all supported transform sizes. Thus the determination of the transform size according to the present invention is significantly simplified.

In video coding, one coding block contains one or more prediction blocks, and one prediction block contains one or more transform blocks. According to one embodiment of the present invention, one transform size is selected for the residues associated with one prediction block. According to another embodiment of the present invention, one transform size is selected for the residues associated with one coding block. In the present invention, the transform size is determined without performing cost comparison among a group of supported transform sizes. The determination of the transform size is based on encoder information, external information, or both.

In one embodiment of the present invention, external information of the video encoding system is taken into consideration for transform size determination. The term “external information” used in this disclosure refers to any factor that is “external” to the underlying coding process. This external information may be associated with the software/hardware system used to implement the underlying video coding. This external information may also be associated with the environment that the underlying coding is used. Depending on the particular implementation, the transform size selected may have different impact on the power consumption or processing time associated with the software/hardware system. The power consumption and processing time play an important role in system design. For example, in the mobile or portable environment, the mobile or portable devices are operated based on batteries and the battery capacity is limited. Therefore, power consumption will directly affect how long the devices can last in various operational modes.

A larger transform size may result in higher power consumption or lower power consumption. A larger transform size may also result in longer processing time or shorter processing time. For example, in one implementation, the computational complexity of transform size N×N is equal to N³. Therefore, the complexity for transform size 16×16 is 4096 (=16×16×16). If the 16×16 block is partitioned into four 8×8 transform blocks, the complexity is 2048 (=4×8×8×8). If the 16×16 block is partitioned into sixteen 4×4 transform blocks, the complexity is equal to 1024 (=16×4×4×4). Accordingly, a larger transform size in this case will result in higher complexity. Higher complexity implies more circuits or more digital logic to implement the transform process. Alternatively, it may take longer time for a given software/hardware to perform the transform process with a larger transform size. Consequently, larger transform size will result in higher power consumption and longer processing time in this case. In another exemplary implementation, the computational complexity for transform size N×N is equal to N×log₂ N. Therefore, the complexity for transform size 16×16 is 64 (=16×log₂ 16). If the 16×16 block is partitioned into four 8×8 transform blocks, the complexity is 96 (=4×8×log₂ 8). If the 16×16 block is partitioned into sixteen 4×4 transform blocks, the complexity is equal to 128 (=16×4×log₂ 4). Accordingly, a larger transform size will result in lower complexity in this case. Lower complexity implies less circuits or less digital logic to implement the transform. Alternatively, it may take shorter time for a given software/hardware to perform the transform process with a larger transform size. Consequently, larger transform size will result in lower power consumption and shorter processing time in this case.

The above analysis illustrates examples of impact of transform size on power consumption and processing time. Depending on a particular implementation, a larger transform size may result in higher power consumption/longer processing time, or lower power consumption/shorter processing time. These factors related to system implementation (a type of external information) can be used to determine the transform size to reduce complexity or power consumption/processing time. An example of transform size determination for a prediction block or a coding block according to an embodiment of the present invention is shown in Table 1 for the case that a larger transform size results in lower power consumption. As shown in Table 1, a small transform size (i.e., 4×4) is selected for a system that has large power budget. On the other hand, a large transform size (i.e., 16×16) is selected for a system that has limited power budget. An example of transform size determination for a prediction block or a coding block according to another embodiment of the present invention is shown in Table 2 for the case that a larger transform size results in higher power consumption. As shown in Table 2, a small transform size is selected if the system power budget is limited.

TABLE 1

| Power budget | Transform size |
|---|---|
| Large | 4 × 4 |
| Medium | 8 × 8 |
| Limited | 16 × 16 |

TABLE 2

| Power budget | Transform size |
|---|---|
| Large | 16 × 16 |
| Medium | 8 × 8 |
| Limited | 4 × 4 |

The determination of the transform size may depend on the computational capability of the encoder or the amount of the time budget for coding a block of pixels. If the software or hardware implementation requires less processing time for larger transform sizes, a larger transform size is selected if a system has less time budget or lower computational capability. For example, some processing steps in HEVC encoding are characterized as serial processing (e.g., reconstruction, deblocking and loop filtering) and cannot be performed in parallel. Thus, a smaller transform size results in longer processing time. In this case, using a larger transform size can reduce the processing time. An example of transform size determination for a prediction block or a coding block according to an embodiment of the present invention is shown in Table 3 for the case that a larger transform size results in less processing time. As shown in Table 3, a large transform size is selected if the system time budget is short. An example of transform size determination for a prediction block or a coding block according to an embodiment of the present invention is shown in Table 4 for the case that a larger transform size results in longer processing time. As shown in Table 4, a small transform size is selected if the system time budget is short.

TABLE 3

| Time budget | Transform size |
|---|---|
| Short | 16 × 16 |
| Medium | 8 × 8 |
| Long | 4 × 4 |

TABLE 4

| Time budget | Transform size |
|---|---|
| Short | 4 × 4 |
| Medium | 8 × 8 |
| Long | 16 × 16 |

Besides power consumption and processing time, the transform size may also have impact on other system characteristics such as system bandwidth or network transmission (e.g., video transmission). The system bandwidth is always limited for a given system. Data access will experience delay or the data becomes unavailable or lost if the required bandwidth exceeds the available bandwidth. An embodiment according to the present invention takes into consideration of system bandwidth for transform size selection. For example, a smaller transform size may need more information during encoding. Also, a smaller transform size may incur more overhead during memory access and reduce effective system bandwidth. In a coding system using multi-core processing, a large transform size will reduce the required communication between different processing cores if independent processing tasks are performed by the multiple cores. Accordingly, the system will select a small transform size if the system has strict system bandwidth requirement. On the other hand, if the system has high system bandwidth, a small transform size may be selected.

When the coding system is used in a real-time environment, particularly in a two-way transmission environment, the determination of transform size may also take into account the network transmission. If the decoder can provide coding requirements back to the encoder, the encoder may select a proper transform size accordingly. For example, a decoder may adopt particular decoder implementation that results in longer decoding time or higher power consumption for smaller transform size. When the decoder wants to reduce the decoding time or power, the decoder may request the encoder to change to a larger transform size.

The transform size determination as described above is based on external information such as power consumption, processing time, system bandwidth, decoder capability, etc. Embodiments of the present invention may also select a transform size according to encoder information. The encoder information in this disclosure refers to coding parameters selected by the encoder or any video data characteristics that can be measured by the encoder. For example, the transform size selection can be purely based on the prediction block size or the coding block size as shown in Table 5.

TABLE 5

| Size of Intra prediction unit or | |
|---|---|
| coding unit | Transform size |
| 16 × 16 | 16 × 16 |
| 8 × 8 | 8 × 8 |
| 4 × 4 | 4 × 4 |

In another embodiment, the transform size is based on the Intra prediction direction selected for the prediction block or the coding block as shown in Table 6. If the Intra prediction direction is horizontal or vertical, the 8×8 transform size is selected. If the Intra prediction direction is diagonal, the 4×4 transform size is selected.

TABLE 6

| Best intra prediction direction | Transform size |
|---|---|
| Horizontal | 8 × 8 |
| Vertical | 8 × 8 |
| Diagonal | 4 × 4 |

According to another embodiment of the present invention, the transform size selection is based on a measurement of residues resulted from the Intra prediction. For example, the variance of the residues can be used. If the variance of the residues is large, it implies that the residues contain high activities and a smaller transform size may result in better compression performance. An exemplary transform size selection according to the present invention is shown in Table 7, where the variance of the residues is compared with a pre-defined threshold. If the variance of the residues is greater than the pre-defined threshold, the 16×16 transform size is selected. Otherwise, the 8×8 transform size is selected. While the variance of the residues is used as a measurement of signal activity, other measurement may also be used. For example, a mean-squared value may be used.

TABLE 7

| Residues comparison result | Transform size |
|---|---|
| Variance of residues <= Pre- | 16 × 16 |
| defined threshold | |
| Variance of residues > Pre- | 8 × 8 |
| defined threshold | |

In yet another embodiment of the present invention, the transform size is determined based on frequency characteristics of the residues. For example, the sum of absolute values for high frequencies of the residues is compared with the sum of absolute values for low frequencies of the residues. If the frequency characteristics indicate that the residues have more signal contents in the high frequency region than the low frequency region, it implies that the residues correspond to signals with high activities. In this case, a smaller transform block may result in better compression performance. Otherwise, a larger transform block may result in better compression performance. An exemplary transform size selection according to the present invention is shown in Table 8. If the sum of absolute values for high frequencies of the residues is greater than the sum of absolute values for low frequencies of the residues, the 4×4 transform size is selected. Otherwise, the 16×16 transform size is selected. The division between the high frequencies and low frequencies can be arbitrary or can be equally split in the middle of zigzag scanned frequencies.

TABLE 8

| Frequency comparison result | Transform size |
|---|---|
| Sum of absolute values of high | 4 × 4 |
| frequencies > Sum of absolute values | |
| of low frequencies | |
| Sum of absolute values of high | 16 × 16 |
| frequencies <= Sum of absolute values | |
| of low frequencies | |

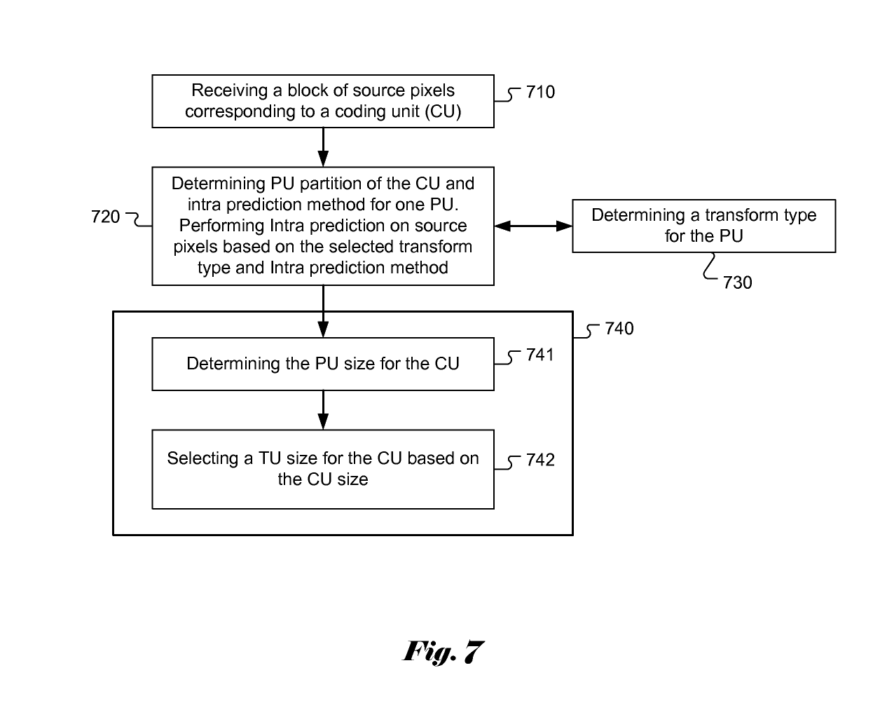

FIG. 6 illustrates an exemplary flow chart of TU size determination for the prediction unit (PU) according to one embodiment of the present invention. A TU size is selected for the PU without performing cost comparison associated with a group of supported TU sizes for the PU. As shown in FIG. 6, one block of source pixels 610 is received, where the block of pixels corresponds to PU pixels to be processed by Intra prediction. The transform type is determined in step 630 and the transform type determined is provided to step 620, where the Intra prediction method is determined and Intra prediction is performed according to the selected Intra prediction method and the transform type. Also Intra prediction according to the selected transform type and Intra prediction method is performed on the source pixels to form prediction residues in step 620. In HEVC, the transform type for an Intra-coded block corresponds to DCT or DST. The TU size for the PU is determined in step 640, where the size of the PU is identified first in step 641. The TU size from a group of supported TU sizes is then determined based on the PU size in step 642. The mapping from the PU size to the TU size can be based on a table, such as Table 5.

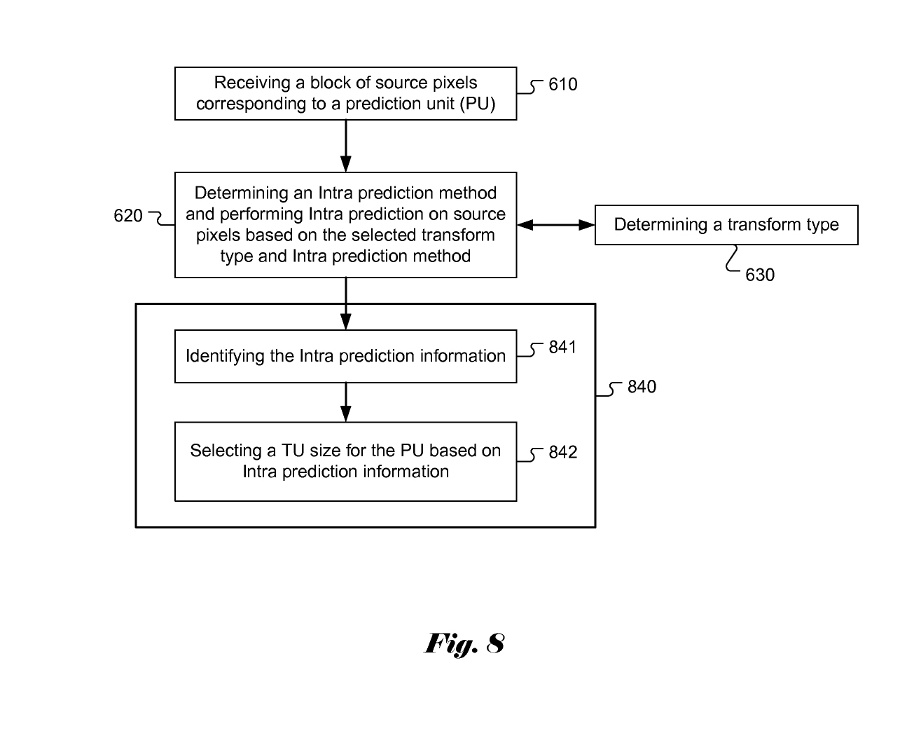

According to another embodiment of the present invention illustrated by FIG. 7, the TU size of each coding unit (CU) is be determined once the CU size is determined without performing cost comparison among the supported TU sizes of the CU. As shown in FIG. 7, a block of source pixels is received in step 710, where the block of pixels corresponds to a CU of pixels to be processed by Intra prediction. The transform type is determined in step 730 and the transform type determined is provided step 720 where the Intra prediction method is determined for a PU of the CU. The residues for the CU are formed by applying Intra prediction based the selected transform type and prediction method. The TU size is determined for the selected CU in step 740. The PU size is identified first in step 721 for the PU to be processed. Then the TU size is determined from a group of supported TU sizes based on the CU size in step 742. The mapping from the CU size to the TU size can be based on a table, such as Table 5.

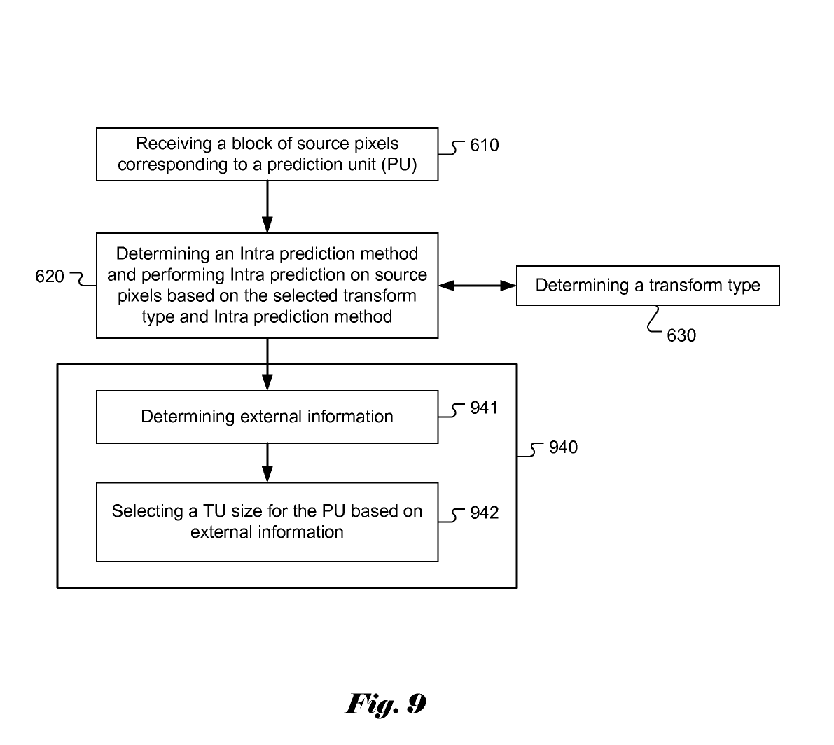

According to another embodiment of the present invention, the Intra prediction information is used to determine the transform size for a given prediction block. The Intra prediction information can be the prediction direction or a measurement of the prediction residues. FIG. 8 illustrates an exemplary flow chart for a coding system incorporating an embodiment of the present invention. The processing steps are similar to those in FIG. 6 except for step 840. After the residues are formed, the Intra prediction information is identified in step 841 and the TU size for the PU is selected based on the Intra prediction information in step 842. The mapping from the Intra prediction information to the TU size can be based on a table such as Table 6. While FIG. 8 illustrates an example of transform size selection based on Intra prediction direction, the transform size selection may also be based on other measurement of residues. For example, the transform size selection may also be based on the variance of the residues as shown in Table 7 or the comparison result between the sum of absolute values for high frequencies of the residues and the sum of absolute values for low frequencies of the residues as shown in Table 8.

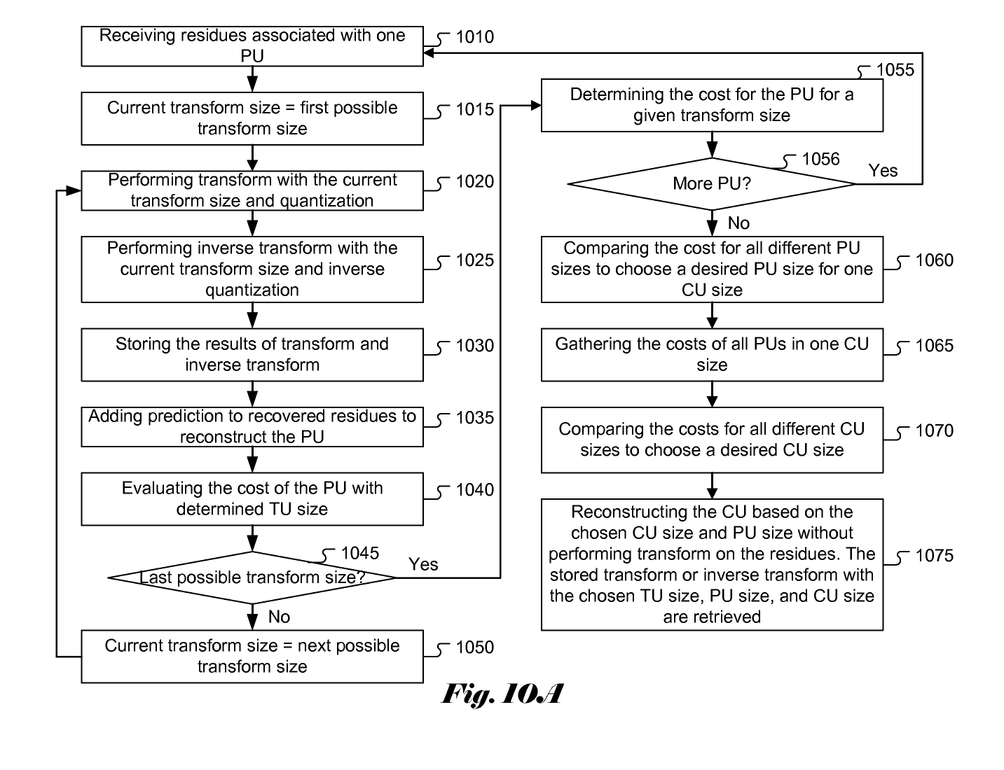

FIG. 9 illustrates an exemplary flow chart for a coding system incorporating another embodiment of the present invention. The processing steps are similar to those in FIG. 6 except for step 940. After the residues are formed, the external information is determined in step 941 and the TU size for the PU is based on the Intra prediction information in step 942. The external information may be related to the capability of the software/hardware coding systems implementing the coding process. For example, the external information may correspond to system processing time or power consumption associated with the transform size. The mapping from the external information to the TU size can be based on a table, such as one selected from Table 1 through Table 4.

As mentioned before, in a conventional encoding system incorporating rate-distortion optimization, the transform process has to be performed for each prediction unit with all possible transform sizes during the cost evaluation stage. After the best transform size is determined for each prediction unit, the transform process with the transform size selected is applied to the residues corresponding to the PU during the reconstruction stage. Therefore, the transform process is performed during cost evaluation and video data reconstruction. According to an embodiment of the present invention, transform process is only performed once during encoding a prediction block. The transform can be performed either during evaluating the cost of each prediction block or during reconstructing each prediction block. In order to perform transform for only one time during cost computation or evaluation on each prediction block, the results of transform or inverse transform have to be stored in memory. When the process of data reconstruction is performed, the results of transform or inverse transform are read from the memory.

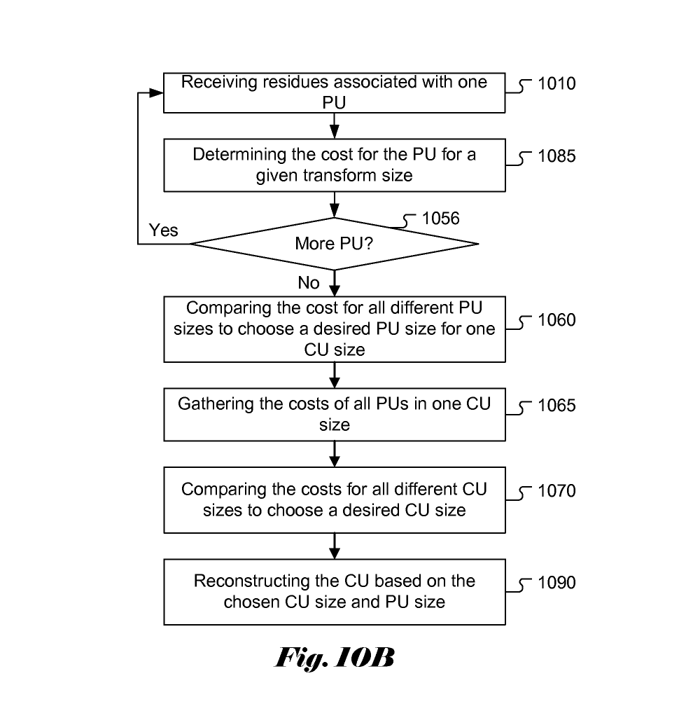

FIG. 10A illustrates an exemplary flow chart for a coding system where the transform process is performed only during the cost evaluation. The encoding system incorporates rate-distortion optimization process to determine best CU partition, PU partition and TU partition. Therefore, for a given CU, the cost associated with each CU size has to be determined. In order to determine the cost for each CU size, the costs for all possible PU sizes associated with one CU size have to be evaluated. Furthermore, for each given PU size, the residues associated with the PU are partitioned into different TU sizes. The costs associated with the all possible combinations have to be evaluated and compared in order to determine a desired CU size and PU size. The steps (1010 through 1050) shown on the left side of FIG. 10A are intended for computing the costs all TU sizes associated with each PU of a given CU size. The loop related to steps 1020 through 1050 computes the costs for all possible TU sizes associated with each PU. The forward and inverse transforms for a given transform size are performed in steps 1020 and 1025 respectively. The results of transform and/or inverse transform are stored as shown in step 1030. After all the costs associated with all TU sizes for each PU are determined, the transform size can be determined for each PU in step 1055. In step 1056, it is determined whether or not there is any more PU of the given CU size to be processed by steps 1010 through 1050. The cost for all different PU sizes are compared to determine the best PU size for one CU size as shown in step 1060. The costs of all PUs in one CU size are gathered in order to compute the cost for one CU as shown in step 1065. The costs for all different CU sizes are compared to choose a desired CU size in step 1070. The CU is then reconstructed based on the chosen CU and PU sizes by retrieving the transform or inverse transform data as stored in memory as shown in step 1075. Accordingly, there is no need to perform transform or inverse transform in the reconstruction stage. For one-time transform process on a given PU, the flow chart in FIG. 10A can be simplified by removing the steps related to decision of the CU partition.

In FIG. 10A, the rate-distortion based optimization is fairly complicated since all possible TU sizes have to be evaluated. One embodiment of the present invention incorporating one-time transform process selects one transform size among a range of possible transform sizes for the CU. A flow chart for a coding system incorporating one-time transform process and a selected transform size among a range of possible transform sizes for a CU is shown in FIG. 10B. After the residues associated with each PU are received in step 1010, there is no need to go through the loop on the left portion of FIG. 10A to compute the costs for all possible transform sizes. The transform and inverse transform can be performed in the cost evaluation stage, i.e., in step 1085. However, the transform and inverse transform can also be performed in the reconstruction stage (1090).

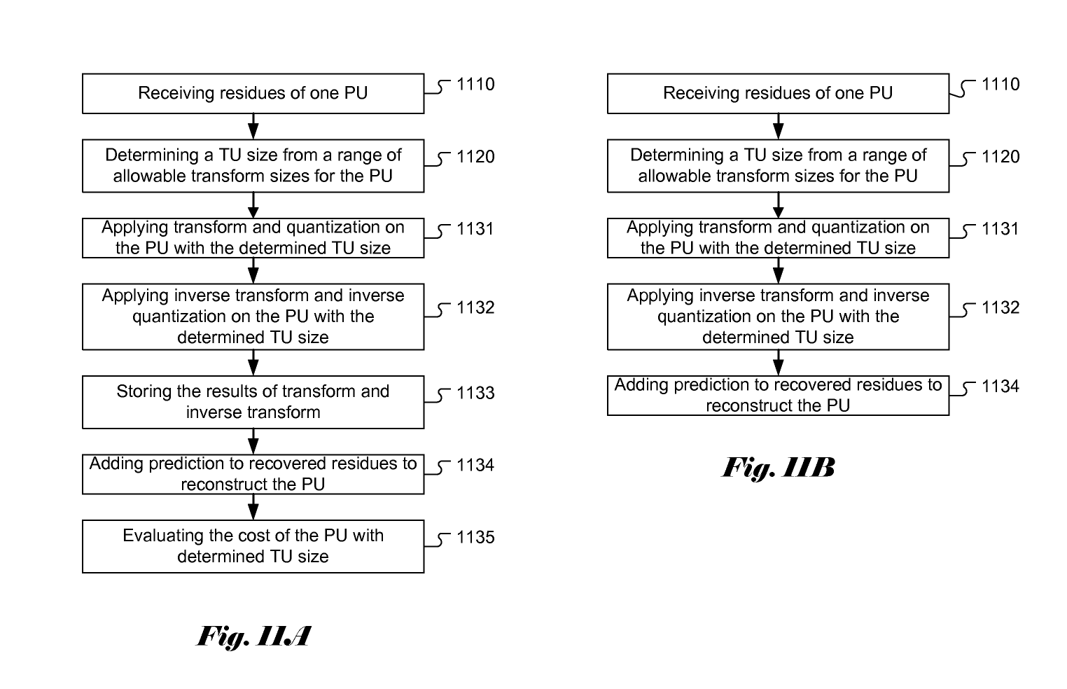

FIG. 11A illustrates an exemplary flow chart of a video coding system incorporating one-time transform and a selected transform size among a range of possible transform sizes during cost computation for each PU according to the present invention. The range of possible or allowable transform sizes includes a group of supported transform sizes. The residues for a PU are received in step 1110. In step 1120, the TU size is determined from a range of allowable transform sizes. For example, the transform size determination described above (i.e., Table 1 to Table 8) can be used. Cost computation are performs in steps 1131 through 1135 including forward transform and inverse transform. The residues associated with the PU are transformed and quantized with the determined TU size in step 1131 which is followed by inverse quantization and inverse transform in step 1132. The results of transform and inverse transform are stored in memory in step 1133. In order to compute the cost of the PU, the prediction is added to the residues to reconstruct the PU in step 1134. Then the cost of the PU is estimated in step 1135. In the reconstruction stage of the PU, transform and inverse transform will not be performed. To reconstruct the PU, the results of transform and inverse transform are read back from memory and are added to the prediction data to form the reconstructed PU. There is no need to perform transform or inverse transform in the reconstruction stage.

According to another embodiment of the present invention, transform function is performed only once during the process of video data reconstruction. FIG. 11B illustrates an exemplary flow chart of video coding performing one-time transform during reconstruction of the PU. The reconstruction process is similar to the cost evaluation process shown in FIG. 11A. However, there is no need to store the transform and inverse transform results for future use. Also, there is no need to evaluate the cost in the reconstruction process.

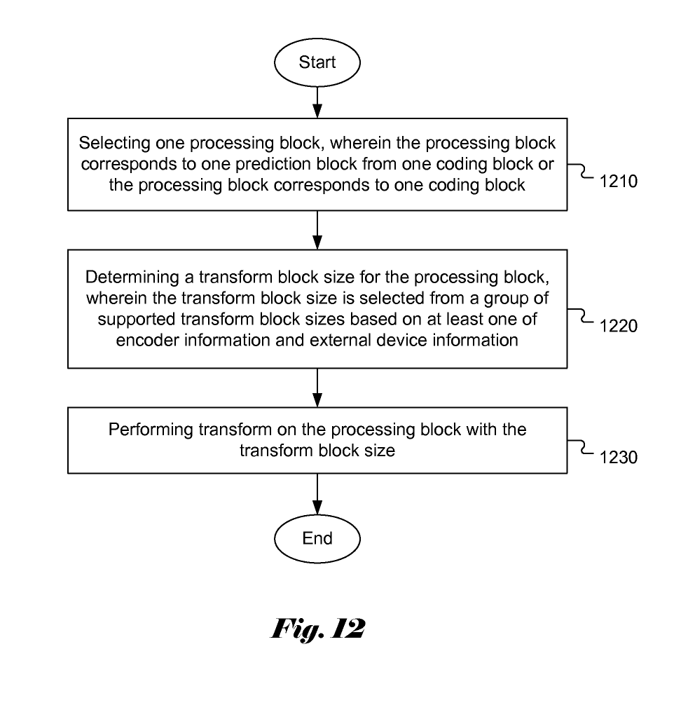

FIG. 12 illustrates an exemplary flow chart of a video coding system using a selected transform size from a range of transform sizes without performing cost comparison among different transform sizes according to one embodiment of the present invention. When the video data is received, one processing block is selected in step 1210. The processing block can be one coding block or a prediction block of one coding block. The transform size for the processing block is selected from a group of supported transform sizes in step 1220. The determination of the transform size is based on encoder information, external information or both. The transform size determination is performed without cost comparison among the group of supported transform sizes of the processing block. The transform for the selected processing block is performed based on the selected or determined transform size in step 1230. The processing block may consist of a plurality of pixels processed by Intra prediction. The coding block can be an Intra prediction coding block. The transform size is selected from a group of supported transform sizes based on at least one of encoder information and external information. The flow of performing transform may further include a step of sharing prediction information for all the transform blocks inside the processing block. The encoder information can be selected from a group consisting one of the two following information: the size information of the selected processing block or the prediction information. The prediction information can be the prediction direction, the analysis result based on the residues generated by Intra prediction process, or both. The external information can be selected from a group comprising: the system bandwidth, the network bandwidth, the system power, the remaining energy or dump energy of the battery in a mobile device, the timing budget for coding a plurality of pixels and computation capability of a system.

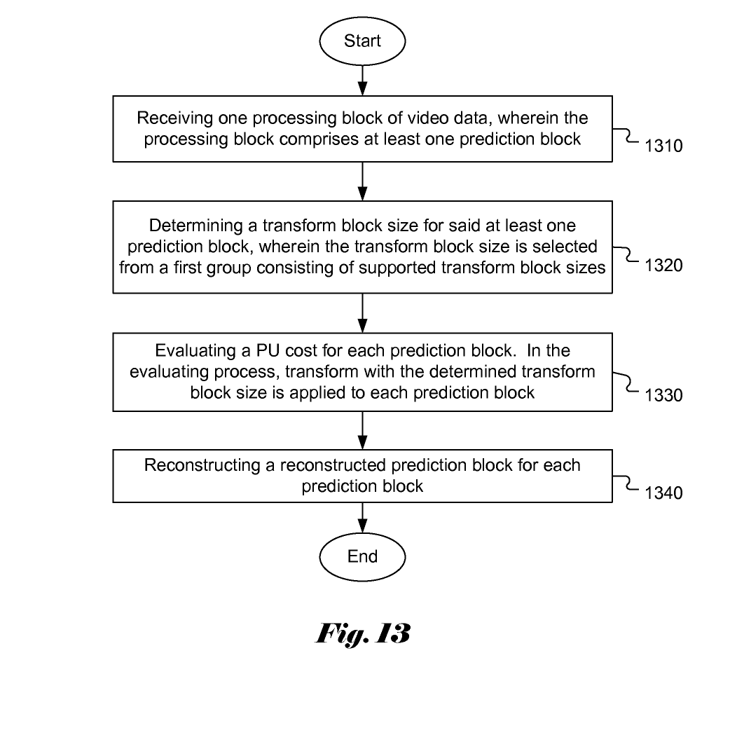

FIG. 13 illustrates an exemplary flow chart of applying transform processing in evaluating a PU cost for each prediction block according to one embodiment of the present invention. One processing block is received in step 1310. The processing block comprises at least one prediction block. In step 1320, one transform size is determined for one prediction block or said at least one prediction block in one processing block. The determination of transform size is made by selecting one transform size from a group of supported transform sizes of the selected processing block. The transform size may be determined based on encoder information, external information or both. The PU cost for each prediction block is evaluated in step 1330. In the cost evaluating process, transform with the determined transform size is applied to each prediction block. One reconstructed prediction block for each prediction block is reconstructed in step 1340.

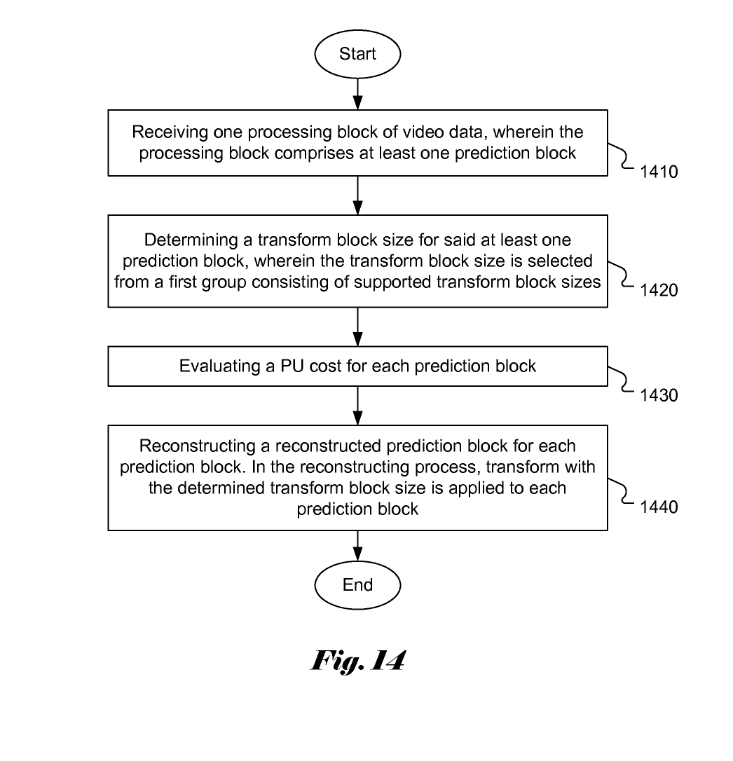

FIG. 14 illustrates an exemplary flow chart of applying transform processing in reconstructing a reconstructed prediction block for each prediction block according to one embodiment of the present invention. Different from the flow chart shown in FIG. 13, transform with the determined transform size is applied to each prediction block in the reconstruction stage each prediction block as shown in step 1440.

The exemplary flowcharts shown in FIG. 6 through FIG. 14 are for illustration purpose. A skilled person in the art may re-arrange, combine steps or split a step to practice the present invention without departing from the spirit of the present invention.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of applying transform processing to video data in a video coding system, wherein the video data is divided into a plurality of coding blocks, the method comprising:
selecting one processing block, wherein the processing block corresponds to one prediction block from one coding block or the processing block corresponds to one coding block;
determining a transform size for the processing block, wherein the transform size is selected from a first group of supported transform sizes based on encoder information, external information or both, wherein the transform size is selected without performing cost comparison among the first group of supported transform sizes; and
performing transformation on the processing block with the transform size.

2. The method of claim 1, wherein the coding block corresponds to one Intra prediction coding block.

3. The method of claim 1, wherein the processing block consists of a plurality of pixels processed using Intra prediction.

4. The method of claim 1, wherein the encoder information is selected from a second group consisting of size information of the processing block and prediction information of the processing block.

5. The method of claim 4, wherein the prediction information comprises at least one of prediction direction and an analysis result of residues generated by a prediction process.

6. The method of claim 1, wherein the external information is selected from a third group consisting of:
a first amount of system bandwidth;
a second amount of network bandwidth;
a third amount of system power;
a fourth amount of remaining energy of a battery in a mobile device;
a fifth amount of timing budget for coding a plurality of pixels; and
computation capability of the video coding system.

7. The method of claim 1, further comprising sharing Intra prediction information for transform blocks inside the processing block when the processing block consists of a plurality of transform blocks.

8. A method of applying transform processing to video data in a video coding system, the method comprising:
receiving one processing block of the video data, wherein the processing block comprises at least one prediction block;
determining a transform size for said at least one prediction block, wherein the transform size is selected from a first group consisting of supported transform sizes;
evaluating a prediction unit (PU) cost for each prediction block; and
reconstructing a reconstructed prediction block for each prediction block,
wherein transformation with the transform size determined is applied to each prediction block only in said evaluating the PU cost for each prediction block or only in said reconstructing the reconstructed prediction block for each prediction block.

9. The method of claim 8, wherein the processing block corresponds to one prediction block.

10. The method of claim 8, wherein the processing block corresponds to one coding block and the coding block is divided into one or more prediction blocks according a coding unit (CU) partition selected from a partition set, the method further comprising:
selecting a desired CU partition according to CU costs associated with the CU partitions of the partition set, wherein the CU cost associated with one CU partition is determined based on the PU costs of said one or more prediction blocks generated from the coding block according to said one CU partition; and
reconstructing the coding block based on the reconstructed prediction blocks generated from the coding block according to the desired CU partition.

11. The method of claim 10, wherein the coding block corresponds to an Intra prediction coding block.

12. The method of claim 8, wherein each prediction block consists of a plurality of pixels generated using Intra prediction.

13. The method of claim 8, wherein the transform size is selected from a second group consisting of encoder information and external information.

14. The method of claim 13, wherein the encoder information is selected from a third group consisting of size information of the coding block and prediction information of the processing block.

15. The method of claim 14, wherein the prediction information comprises at least one of prediction direction and an analysis result of residues generated by a prediction process.

16. The method of claim 14, wherein the external information is selected from a fourth group consisting of:
a first amount of system bandwidth;
a second amount of network bandwidth;
a third amount of system power;
a fourth amount of remaining energy of a battery in a mobile device;
a fifth amount of timing budget for coding a plurality of pixels; and
computation capability of the video coding system.

17. The method of claim 8, further comprising sharing Intra prediction information for transform blocks inside each prediction block.

18. An apparatus of applying transform processing to video data in a video coding system, wherein the video data is divided into a plurality of coding blocks, the apparatus comprising:
means for selecting one processing block, wherein the processing block corresponds to one prediction block from one coding block or the processing block corresponds to one coding block;
means for determining a transform size for the processing block, wherein the transform size is selected from a group of supported transform sizes based on encoder information, external information or both, wherein the transform size is selected without performing cost comparison among the group of supported transform sizes; and
means for performing transformation on the processing block with the transform size.

19. An apparatus of applying transform processing to video data in a video coding system, the apparatus comprising:
means for receiving one processing block of the video data, wherein the processing block comprises at least one prediction block;
means for determining a transform size for said at least one prediction block, wherein the transform size is selected from a group consisting of supported transform sizes;
means for evaluating a prediction unit (PU) cost for each prediction block; and
means for reconstructing a reconstructed prediction block for each prediction block,
wherein transformation with the transform size determined is applied to each prediction block only in said evaluating the PU cost for each prediction block or only in said reconstructing the reconstructed prediction block for each prediction block.
